(19) United States
(12) Patent Application Publication
(10) Pub. No.: US 2009/0152878 A1
(43) Pub. Date: Jun. 18, 2009

(54) RESETTABLE RELEASE LATCH

(75) Inventor: Richard James LaConte, Black Diamond, WA (US)

Correspondence Address: JENSEN + PUNTIGAM, P.S., 2033 6th Ave, Suite 1020, SEATTLE, WA, 98121, US

(73) Assignee: Harper Engineering Co., Renton, WA (US)

(21) Appl. No.: 11/955,796

(22) Filed: Dec. 13, 2007

(51) Int. Cl. E05B 15/00

(52) U.S. Cl. 292/254

(57) ABSTRACT

A resettable securement latch for a panel which allows release of the panel upon a predetermined pressure across the panel and includes means incorporating a frangible element which can be quickly restored to resecure the panel to its original position and condition.

### TECHNICAL FIELD

This invention relates to release latches, and particularly to those designed for airplane ceiling panels, and more particularly to a latch which will secure a panel in place, yielding to sudden movements or changes in relative pressure, but including means to quickly reset the latch, resecuring the panel.

### BACKGROUND OF THE INVENTION

It is known to have adjustable pressure or blow-off latches for use on the exterior of an airplane, as taught by U.S. Pat. No. 5,765,883 granted to Dessenberger et al, Jun. 16, 1998; U.S. Pat. No. 6,513,841 granted to Jackson, Feb. 4, 2003; and U.S. Pat. No. 6,755,448 granted to Jackson et al., June 29, 2004.

Interior aircraft panels and load-regulating latches are also known, as taught by U.S. Pat. No. 4,739,955 granted to Aquino, Apr. 26, 1988; U.S. Pat. No. 4,045,063 granted to Fletcher et al., Aug. 30, 1977; and U.S. Pat. No. 6,866,226. granted to Pratt et ac, March S 2005. It is assumed that each of these latches operates in the manner described, which is primarily to release a panel upon a pre-determined change in pressure or adjust loads of structures in response to a change in pressure caused by rapid movements or the like.

### DISCLOSURE OF THE INVENTION

It is a feature of the present invention that the latch is designed to hold a ceiling panel of an airplane in place but will release the panel upon reaching a pre-determined variable pressure on opposing sides of the panel and yet can be readily reset for resecurement of the panel.

Yet another feature of the present invention is the inclusion of a shear surface within the latch through which a frangible rod is exposed and which results in shearing of the rod upon reaching a predetermined frangible pressure upon opposite sides of a secured panel. The residual rod is then moved forwardly to reset the latch again serving as the latch release threshold.

### BRIEF DESCRIPTION OF THE DRAWINGS

FIG. 1 is an environmental view showing the inventive resettable release latch at the upper end of a ceiling panel in an airplane.

FIG. 2 is an isometric view of the inventive latch in the closed position.

FIG. 3 is a side elevational view of the inventive latch in the closed position and in phantom in the open position.

FIG. 4 is an exploded view of the inventive latch.

FIGS. 5A-5C are side elevational views of the latch showing the operational stage

### BEST MODE FOR CARRYING OUT THE INVENTION

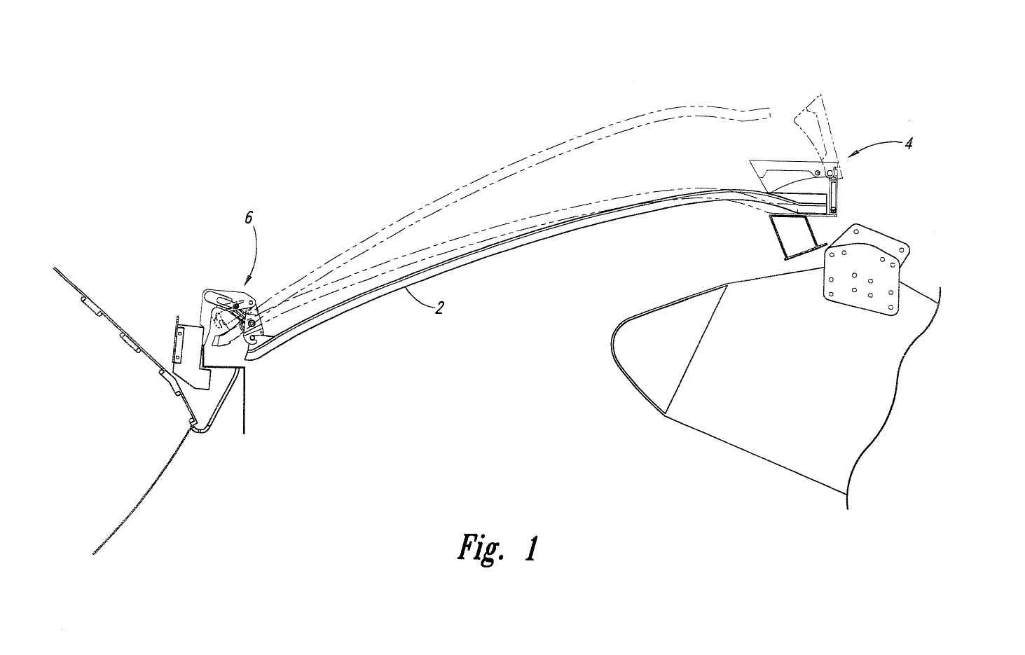

As seen in FIG. 1, the curved ceiling panel 2 is held in position by the inventive resettable release latch 4 and a selective release latch 6. In the illustrated embodiment, the resettable release latch 4 is designed to release the ceiling panel 2 upon a sudden change of pressure between opposite sides of the panel 2; whereas the selective release latch 6 is designed to release the ceiling panel under slow pressure, giving access to the area behind the panel for maintenance and the like while resisting release under sudden movement.

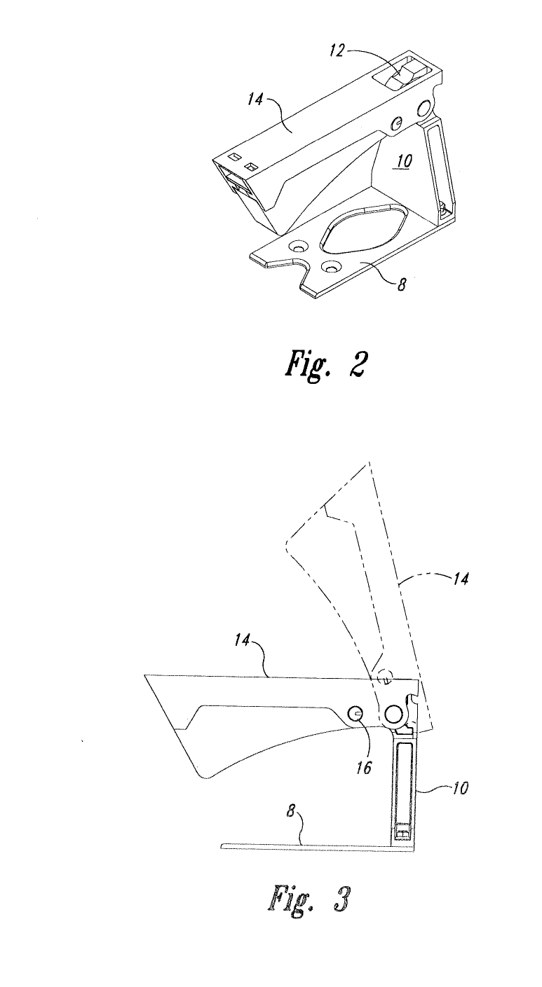

As seen in FIG. 2, the inventive latch includes a base plate 8 for securement to a structural element of the airplane, and has mounted thereon a tower 10 extending upwardly to mate in a head portion 12, described in detail hereinafter, which serves to mount the latch 14, forming a storage area and making available the frangible rod insert, as well as serving as a shear surface. When seen in FIG. 2, the spacing between the base 8 and the bottom portion of rod element 14 is approximately the thickness of the ceiling panel to be secured.

As best seen in FIG. 3, when the latch 14 is moved to its uppermost position, the tip of the frangible rod 16 has been eliminated, as explained hereinafter.

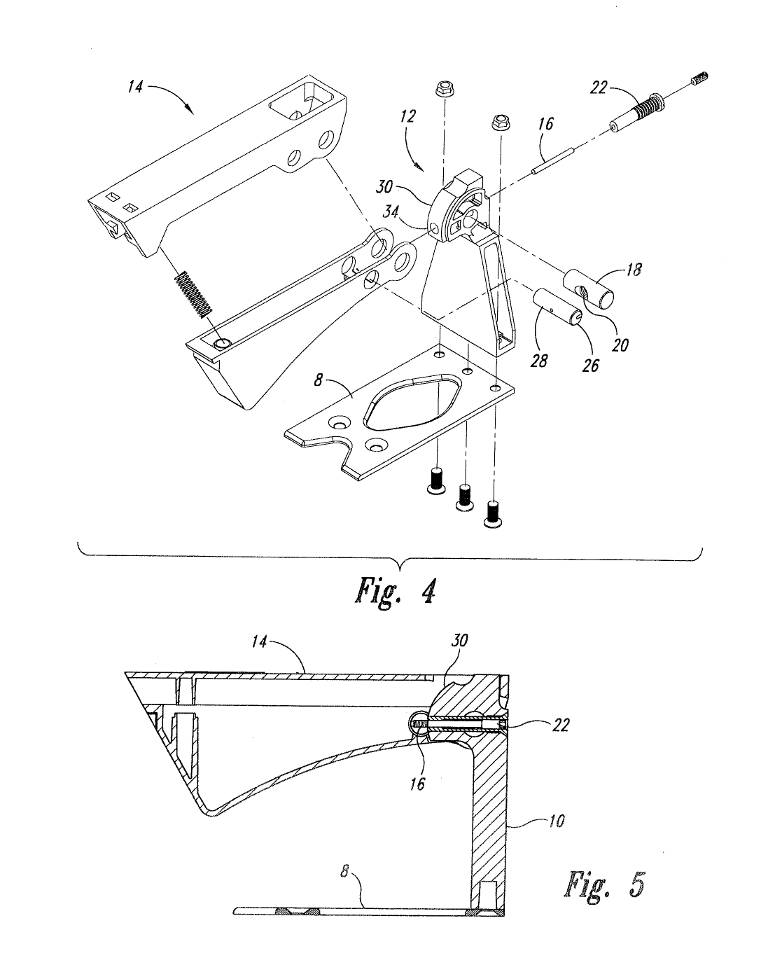

Reference is now had to FIG. 4, wherein it can be seen that the pivot pin 18, which secures the latch arm 14 to the tower, includes a threaded bore 20 to receive a threaded plunger element 22, which in turn receives the frangible rod 16 which extends through pin 18 and bore 74 to terminate in the horizontal groove 26 in pin 28. A curved forward face 30 of head 12 forms an anvil such that when the latch 14 is moved upwardly, pin 28, moving in conjunction with face 30, shears a portion of the frangible rod 16, allowing the latch element 14 to move to the position 14, as seen in FIG. 3.

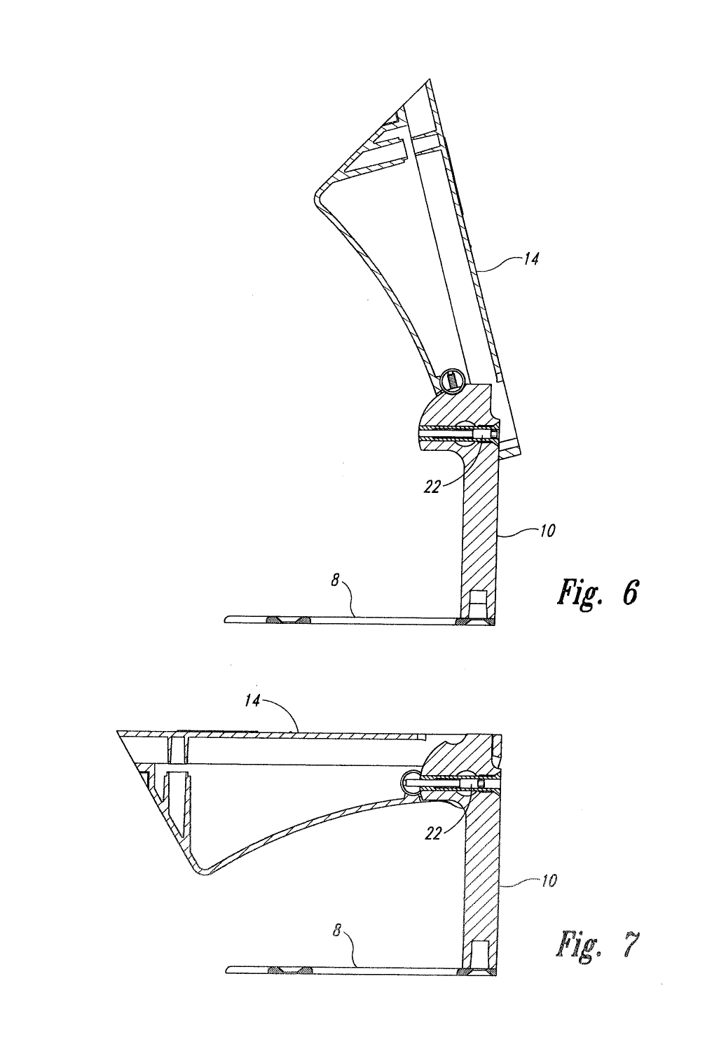

As seen in FIGS. 5A-5C, the latch is in the closed position in 5A securing the ceiling panel in position. Upon a sudden upward movement, the upper portion of the latch 14 pivots upwardly severing the inner end of the frangible rod 16 and allowing the ceiling panel to be released. Wherein the preferred differential has be corrected the upper portion of the latch 14 is returned to its normal position, as seen in FIG. 5C, and the frangible rod 16 is adjusted to again secure the upper portion in the latched position.

It can be seen that once the differential pressure on the panel causes the latch to move upwardly, it shears the outer end of the frangible rod 16, allowing the release of the panel. Upon a return to normal pressure, the latch may be moved to its lowermost position and the frangible rod moved inwardly until the next pressure differential, allowing the operator to quickly and easily restore the panel and its securement to the normal position. It is contemplated that the rod may be biased inwardly such that it may be automatically reset.

Although a preferred embodiment of the invention has been disclosed herein for the purposes of illustration it should be understood that various changes, modifications and substitutions may be incorporated in the embodiment without departing from the spirit of the invention, which is defined by the claims which follow.

What is claimed is:

1. A resettable automatic release latch to secure a panel, comprising:
a base member including an, upwardly extending leg along one edge thereof, said leg including a first bore extending therethrough;
a second bore perpendicular to, smaller than, and intersecting the first bore, said leg terminating in a shear surface;
an outwardly extending arm pivotally secured to the leg adjacent the shear surface by a pin extending through the first bore and a pair of aligned bores in the arm; and
a frangible rod extending through the second bore in the base member beyond the shear surface such that when the arm is moved upwardly with sufficient force, it shears the rod and releases the panel.

2. A release latch as in claim 1, wherein the rod may be adjusted inwardly to reset the latch.

3. A release latch as in claim 1, wherein the rod may be automatically adjusted inwardly to reset the latch.
